(19) United States
(12) Patent Application Publication
(10) Pub. No.: US 2020/0150791 A1
(43) Pub. Date: May 14, 2020

(54) SIGNAL PROCESSING

(71) Applicant: Elliptic Laboratories AS, Oslo (NO)

(72) Inventor: Ludvik LIDICKY, Oslo (NO)

(73) Assignee: Elliptic Laboratories AS, Oslo (NO)

(21) Appl. No.: 16/675,476

(22) Filed: Nov. 6, 2019

(30) Foreign Application Priority Data
Nov. 12, 2018 (NO) 20181444

(51) Int. Cl. G06F 3/043; G06F 3/01

(52) U.S. Cl. CPC G06F 3/043; G06F 3/017

(57) ABSTRACT

This invention relates to a method as well as a computer product, system and device for controlling the frequency range of an emitted ultrasound signal from a device. The device includes a number of acoustic transducers, the method including the step of generating an electronic signal within a predetermined frequency range in the time domain, convolving the said electronic signal with a time envelope function thus providing an emission signal. The time envelop function is calculated based on a transformation of the predetermined frequency range of the emitted signal into the time domain, the emitted acoustic signal being generated by the emission signal.

### TECHNICAL FIELD

The present teachings relate generally to processing of acoustic signals.

### BACKGROUND ART

Different technologies exist for sensing proximity and gestures on electronic devices, e.g. as described in Norwegian Patent Application NO20180146, British publication GB2558768 and US patent U.S. Pat. No. 9,152,276, where both distances and movements are measured using acoustic signals. The system includes transducers emitting and receiving the acoustic signals analyzing them in the time or frequency domain to register both time delay, or distance to the subject, and direction of the received signal.

In mobile phones and similar devices the acoustic signals are often emitted and received by transducers essentially aimed at use within the audible frequency range. One problem occurring in such systems is that when ultrasonic signals are being transmitted in bands close to the audible range, it is important that the band be limited by a steeply decreasing, ideally step-like, function. Doing so has the aim of minimizing the chance that frequency components outside the chosen band occur and can be heard.

More specifically the signals according to the known art occupy a certain frequency band, such as for example chirps, and are usually multiplied with a window function in the time domain in order to minimize the out-of-band frequency components. Various window functions have been devised to trade off the width of the main lobe with the side lobe level. However, any time-limited window of finite width will produce side lobes in the frequency domain, therefore potentially introducing undesirable out-of-band signals. One solution could be to limit the band directly in the frequency domain by means of a rectangular window. Such an operation would produce a time window with an infinite extent with which the original signal would need to be convolved, which would provide a complex and time consuming operation.

The object of the present invention is to provide a method for reducing the side lobes or frequency components extending into the range where they can be heard. This is obtained as specified in the accompanying claims.

### SUMMARY

The method according to the invention thus uses a window designed for shaping the signal spectrum in frequency domain according to desired specifications. The resulting signals may be generated either in time or in frequency domains by means of convolution or the Fourier transform.

The method is intended for use in any ultra sound application utilizing transmitters and receivers capable of operating close to the audible range, especially for proximity measurements or for detecting gestures, e.g. including control signals being detected by the device.

The invention will be described more in detail below with reference to the accompanying drawings illustrating the invention by way of examples

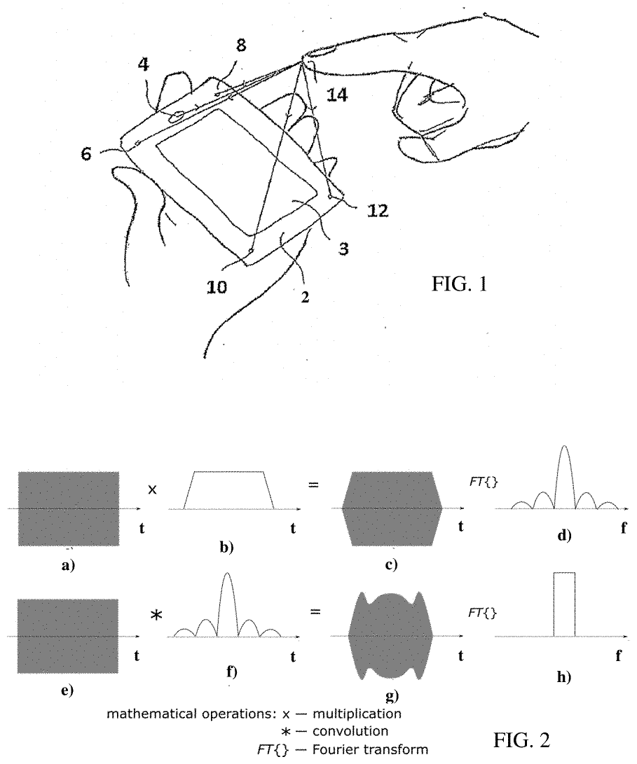

FIG. 1 illustrates a device using the present invention.

FIG. 2 illustrates the signal manipulation according to the known art and the present invention.

FIG. 1 illustrates the device, e.g. as presented in US patent U.S. Pat. No. 9,152,276, where hand gestures are used to control a user interface 3 on a device 2. As can be seen a number of sensors 4,6,8,10,12 are used to measure presence of a finger 14 in the vicinity of the device 3. According to the present invention the sensors 4,6,8,10,12 are acoustic sensors emitting and receiving acoustic signals and the device is adapted to read and interpret the gestures made by the finger. Several transducers are shown in FIG. 1, the number may depend on the practical designs as long as the distance and direction to, as well as the movements, may be detected. According to a preferred embodiment the transducers used for microphone and loudspeaker purposes in the device, especially if the device is a mobile phone or tablet, may be adapted or chosen to also function in the ultrasound range so as to provide an additional functionality according to the present invention.

As is illustrated in FIG. 2 the prior art is essentially constituted by the steps of multiplying a signal a) in the time domain with a time window b), resulting with a time limited frequency signal c). A Fourier transform d) of the windowed signal c) shows that the spectrum has side lobes which, as the initial frequency range is close to the audible range, may have components in the audible range.

According to the present invention the frequency signal e) is multiplied with an envelop signal f) which is generated based on the intended frequency range and profile of the output signal. This convolution results in the emitted signal g). The envelop f) is therefore calculated preferably using an inverse Fourier transform of the required frequency range of the output signal. The resulting emitted signal g). This way the convolution of e) and f) will not include frequencies outside the required range, as shown in h) in FIG. 2.

As stated above the required frequency range of the output signal will be above the audible threshold, at least higher than 20 kHz, but the transducer characteristics, such as nonlinearities, may also be taken into account. Also, the high frequency part of the range may be taken into account so as to avoid interference with other frequency bands close to the range.

Thus the frequency range and profile h) of the output signal g) may be chosen according to a number of variables. Also, even though inverse Fourier transform is mentioned here other transforms from the frequency domain to the time domain are well known and may be used.

The transform from the frequency domain to the time domain may, either by choice or as a result of the type of transform used, give the output a specific signature, especially in the resulting frequency distribution of the output signal. This may act as a code that can be used to identify the device and/or the technology used in the device. Therefore, an external control unit may measure and analyze the output signal of the device and identify the device and implemented software as well as, possible the device itself. The emitted signals will then have an additional purpose.

The device may also include a memory for storing the predetermined frequency range or signature, where the frequency range or signature may be updated so as to change the signature in the frequency domain, either for identification purposes or for improving the sensitivity to external interference.

The present invention thus relates to an electronic device as well as an implemented computer product and a method for using the providing signals that may be used for measuring movements relative to the device.

The device may be a mobile phone, table or other portable or stationary devices, especially devices using user interface based on detecting gestures and similar made by the sued in the vicinity of the device using acoustic signals.

The device includes a number of transducers adapted to emit and receive acoustic signals. In order to detect three dimensions, the number of transducers will usually be at least three, where at least one of the transducers act as transmitted and at least one act as receiver. As is well known the transducers may be chosen that can be both transmitters and transducers.

The device also includes a signal generation circuit adapted to generate an electronic signal in a predetermined frequency range and a calculation unit calculating a convoluted signal based on said electronic signal and a time envelop signal, as is shown in FIG. 2, steps d), e) and f). Thus, generating an output signal being emitted by at least one of said transducers. The time envelop signal e) is generated based on the inverse Fourier Transform h) of the predetermined frequency range of the emitted signal, where the frequency range preferably extends from a lower range higher than the audible range, e.g. 20 kHz, and the upper limit may be defined based on other emitted frequency bands known or detected in the area. In addition, the predetermined frequency range may take into account the response characteristics of the emitting transducer in order to obtain a flat amplitude over the frequency range.

Based on the emitted and received signals the device may then detect position and movements of objects in the vicinity of the device reflecting the ultrasound signals.

The calculated time envelop as well as the known profile of the output signal may be calculated either in the device or externally based on the known features of the device and stored in a memory unit such as a flash memory in the device and be used for calculating the output signal. The profile may also be stored and used by an external device having receiver means adapted to receive and compare a transmitted signal with a known profile. This way the emitted signal profiles may be used as an identification of the device or type of device by recognizing the time envelop and/or frequency profile of the signal.

In this case the calculated profile may be predetermined or broadcasted in a separate acoustic or electromagnetic signal to be received by a present external device adapted to receive and recognize it. The external control unit may be of any suitable, available type being capable of receiving acoustic signals and, if relevant, the broadcasted signal.

1. A method for controlling the frequency range of an emitted ultrasound signal from a device, the device including a number of acoustic transducers, the method including the step of generating an electronic signal within a predetermined frequency range in the time domain, convolving the the electronic signal with a time envelope function thus providing an emission signal,
wherein the time envelop function is calculated based on a transformation of the predetermined frequency range of the emitted signal into the time domain, the emitted acoustic signal being generated by the emission signal.

2. The method according to claim 1, wherein the transform is an inverse Fourier Transform.

3. The method according to claim 1, wherein the low limit of the predetermined frequency range is outside the audible frequency range, at least 20 kHz.

4. The method according to claim 1, wherein the high limit of the predetermined frequency range is determined based on known interfering signals in the environment.

5. The method according to claim 1, wherein the frequency profile, including the amplitude range over the spectrum, is chosen according to known characteristics of the transducers.

6. The method according to claim 1, including a step of measuring the position and movements of an object close to the device by analyzing in the emitted and received signals from the transducers.

7. A computer software product implemented in a device including a number of acoustic transducers, the product being adapted to generate an electronic signal within a predetermined frequency range in the time domain, convolving the the electronic signal with a time envelop function thus providing an emission signal,
the emission signal being calculated via a transform of an input signal spectrum into the time domain and multiplied with a desired spectral window, and wherein the signal spectrum includes the selected frequency range of the emission signal.

8. The computer product according to claim 7, wherein the transform is an inverse Fourier Transform.

9. The computer product according to claim 7, wherein the low limit of the predetermined frequency range is outside the audible frequency range, at least 20 kHz.

10. The computer product according to claim 7, wherein the high limit of the predetermined frequency range is determined based on known interfering signals in the environment.

11. The computer product according to claim 7, wherein the frequency profile, including the amplitude range over the spectrum, is chosen according to known characteristics of the transducers.

12. An electronic device for measuring movements relative to the device, wherein the device includes a number of transducers adapted to emit and receive acoustic signals, wherein the device includes a signal generation circuit adapted to generate an electronic signal in a predetermined frequency range and a calculation unit calculating a convoluted signal based on the electronic signal and a time envelop signal, thus generating an output signal being emitted by at least one of the transducers, wherein, the emitted time-domain signal is generated based on a transform of the predetermined frequency range of the emitted signal into the time domain.

13. The electronic device according to claim 12, wherein the transform is an inverse Fourier Transform.

14. The device according to claim 12, wherein the low limit of the predetermined frequency range is outside the audible frequency range, at least 20 kHz.

15. The device according to claim 12, wherein the high limit of the predetermined frequency range is determined based on known interfering signals in the environment.

16. The device according to claim 12, wherein the frequency profile, including the amplitude range over the spectrum, is chosen according to known characteristics of the transducers.

17. The device according to claim 12, wherein the device is adapted to measure the position and movements of an object close to the device by analyzing in the emitted and received signals from the transducers.

18. The system including an electronic device according to claim 12, also comprising a control unit including an electronic memory device storing the generated envelop signal, the control unit comprising a receiver transducer for receiving the acoustic signal from the electronic device, and a comparing unit for comparing the received signal with the generated envelop signal so as to be able to recognize the received signal and thus verify the electronic device or type of electronic device.
